(19) United States
(12) Patent Application Publication
(10) Pub. No.: US 2017/0159961 A1
(43) Pub. Date: Jun. 8, 2017

(54) AIR FILTER SENSOR, AIR FILTER CLEANING SYSTEM AND REFRIGERANT SENSOR

(71) Applicant: Carl L.C. KAH, III, North Palm Beach, FL (US)

(72) Inventor: Carl L.C. KAH, III, North Palm Beach, FL (US)

(21) Appl. No.: 15/369,272

(22) Filed: Dec. 5, 2016

Related U.S. Application Data
(60) Provisional application No. 62/262,641, filed on Dec. 3, 2015.

(51) Int. Cl. F24F 11/00; B01D 46/42; F24F 13/28; B01D 46/00

(52) U.S. Cl. CPC F24F 11/0086; B01D 46/0086; B01D 46/4245; B01D 46/429; B01D 46/0067; F24F 13/28; B01D 2279/50; F24F 2011/0093; F24F 2011/0038; F24F 2221/22; F24F 2011/0084

(57) ABSTRACT

An air filter sensor is preferably attachable to an air filter and periodically checks the status of the filter based on pressure or air flow changes through the filter. An air filter cleaning system selectively or periodically cleans an air filter using a vacuum tube or tubes to maintain the filter in a substantially clean condition. A refrigerant sensor checks the refrigerant level in an air conditioning system and issues an alert if it drops below a desired threshold.

### CROSS-REFERENCE TO RELATED APPLICATIONS

The present application claims benefit of and priority to U.S. Provisional Patent Application No. 62/262,641 filed Dec. 3, 2015 entitled AIR FILTER SENSOR, AIR FILTER CLEANING SYSTEM AND REFRIGERANT SENSOR, the entire content of which is hereby incorporated by reference herein.

### BACKGROUND

Field of the Disclosure

The present invention relates to an air filter sensor and an air filter cleaning system. In particular, the present application relates to a sensor that monitors air filter performance and provides an alert when cleaning or replacement of the air is necessary. In addition, the present application relates to an air filter cleaning system and a refrigerant sensor for use in an air conditioning system.

Related Art

Air filters are an essential component of air conditioning systems, whether they are residential or commercial systems. In order to run efficiently, the filters must allow for the smooth flow of air, however, during operation, the filters may become blocked by dust or debris. This blockage impedes the flow of air which results in inefficiency in the system that can substantially raise the cost of operating the system. It is difficult, however, to predict how often the filter of a system should be changed in order to maintain good efficiency. Since accessing and changing, or cleaning the filter is often labor intensive and may be expensive, checking the filters repeatedly would be impractical.

Another common cause of inefficiency in both residential and commercial air conditioning systems is leaking refrigerant, such as Freon, for example. Over time, the refrigerant used in these systems may slowly leak and gradually decrease efficiency of the system.

Accordingly, it would be beneficial to provide a sensor to indicate a status of an air filter. It would also be beneficial to provide a system that cleans an air filter when necessary. In addition, it would be beneficial to provide a refrigerant leak sensor.

### SUMMARY

It is an object of the present invention to provide a sensor for an air filter to detect debris build up on the filter and a system for cleaning an air filter as well a sensor to monitor refrigerant levels.

Other features and advantages of the present invention will become apparent from the following description of the invention which refers to the accompanying drawings.

### BRIEF DESCRIPTION OF THE DRAWINGS

FIG. 1 illustrates an air filter sensor in accordance with an embodiment of the present invention.

FIG. 2 illustrates an exemplary block diagram of the air filter sensor of FIG. 1.

FIG. 3 illustrates an air filter sensor in accordance with another embodiment of the present invention.

FIG. 4 illustrates an exemplary block diagram of the air filter sensor of FIG. 3.

FIG. 5 illustrates an air filter sensor in accordance with another embodiment of the present invention.

FIG. 6 illustrates an exemplary block diagram of the air filter sensor of FIG. 5.

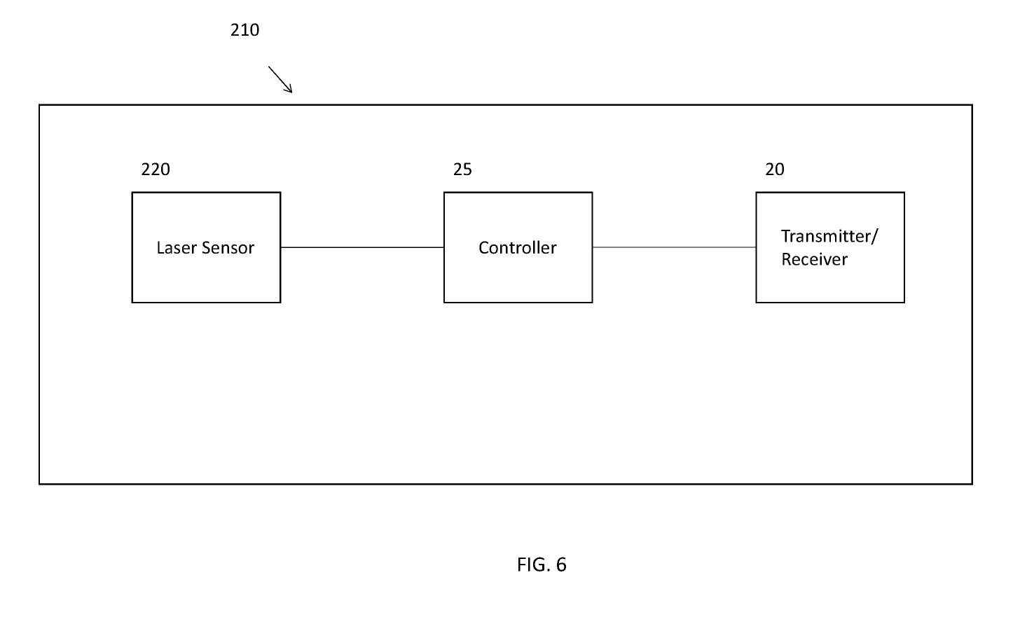

FIG. 7 illustrates an air filter cleaning system in accordance with an embodiment of the present invention.

FIG. 8 illustrates an air filter cleaning system in accordance with another embodiment of the present invention.

FIG. 9 illustrates an air filter cleaning system in accordance with another embodiment of the present invention.

FIG. 10 illustrates an air filter cleaning system in accordance with another embodiment of the present invention.

FIG. 11 illustrates an air filter cleaning system in accordance with an embodiment of the present invention.

### DETAILED DESCRIPTION OF THE EMBODIMENTS

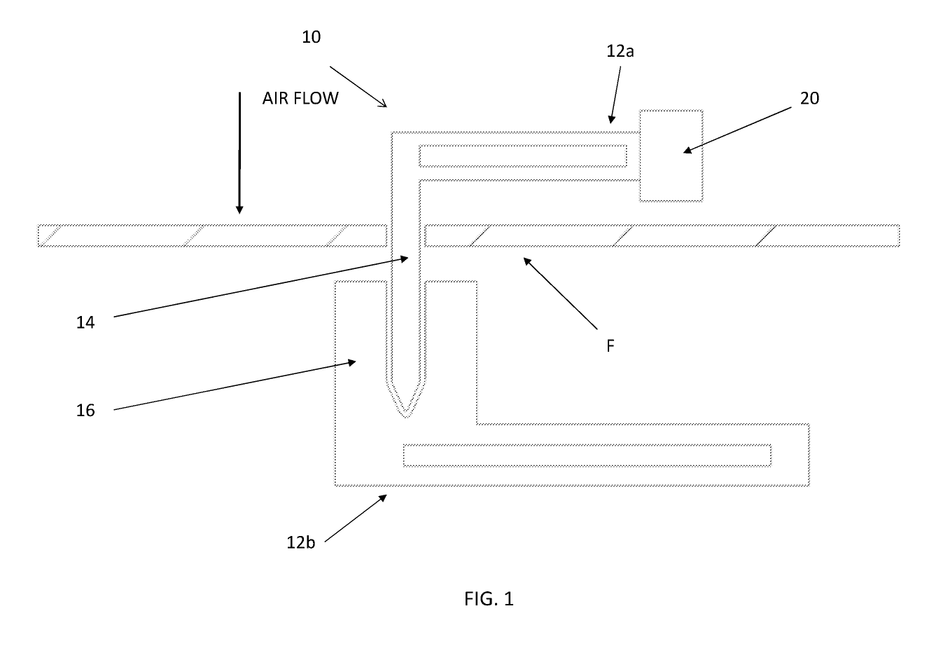

FIG. 1 illustrates an air filter sensor 10 in accordance with an embodiment of the present invention. The sensor 10 preferably includes two pressure sensing devices 12a, 12b that are mounted on opposite sides of an air filter F as can be seen in in FIG. 1. The sensor 10 is preferably secured to the filter F such that one pressure sensing device 12a is provided on a first side of the filter and the other presser sensing device 12b is positioned on the side of filter opposite that of the first pressure sensing device 12a. As indicated by the AIR FLOW arrow in FIG. 1, the pressure sensing device 12a is positioned on the side of the filter F from which air enters the filter and the second pressure sensing device 12b is positioned on the opposite side of the filter, downstream of the first pressure sensing device. The sensor 10 is preferably removably secured to the filter F. In a preferred embodiment, the sensor 10 may be attached to an existing filter F so that it can be used in virtually any air conditioning system. In the alternative, the sensor 10 may be permanently mounted on the filter F. In the embodiment of FIG. 1, fastening is accomplished via a fastening pin 14 that extends from the first pressure sensing device 12a and passes through the filter F and is received in a receiving recess 16 in or attached to the second pressure sensing device 12b. The pin 14 may be secured in the recess 16 via a friction fit or any suitable arrangement. It is noted that any suitable fastener may be used to secure the sensor 10 to the air filter F provided that the first pressure sensing device 12a is provided on one side of the filter and the second pressure sensing device 12b is provided on the opposite side of the filter.

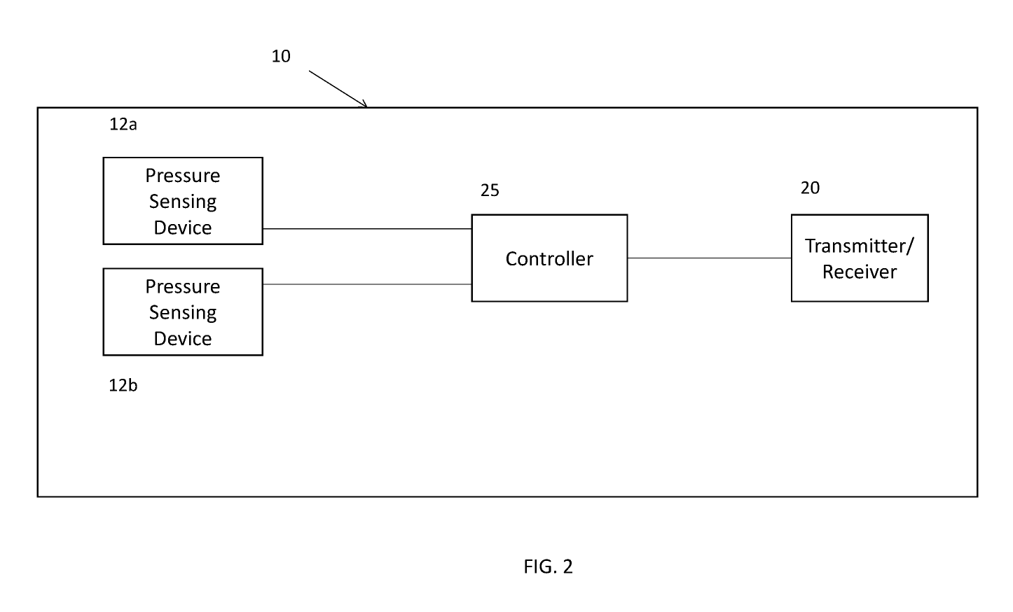

The sensor 10 preferably also includes a wireless transmitter/receiver 20 for at least transmitting data from the sensor. The transmitter/receiver 20 may also be used to receive data, if desired. In a preferred embodiment, the transmitter/receiver 20 is wireless, however, any suitable transmitter/receiver may be used, including but not limited to wired devices and ultrasonic devices. In addition, while not explicitly illustrated, a power source, such as a battery is preferably provided in the sensor 10 as well. While a battery is preferred, any suitable power source may be used. Further, as can be seen in the exemplary block diagram of FIG. 2, the sensor 10 preferably includes a controller 25 connected to the first and second pressure sensing devices 12a, 12b and the transmitter/receiver 20 and preferably powered by the power source. The controller 25 preferably receives pressure information from the first and second pressure sensing devices 12a, 12b and controls the transmitter/receiver to transmit data when desired. The controller 25 may include a memory to store instructions and/or other data received from the first and second pressure sensing devices 12a, 12b or from outside the sensor 10 via the transmitter/receiver 20, for example. If desired, the sensor 10 may include an input device such as a button, switch or dial to provide information to the sensor.

In operation, the first pressure sensing device 12a and the second pressure sensing device 12b periodically measure the air pressure on opposite sides of the filter F. The difference between the air pressure detected by the first pressure sensing device 12a and that of the second pressure sensing device 12b is indicative of the pressure drop across the filter F. The more clogged the filter F is, the larger the pressure drop across the filter will be, and thus, the larger the difference in pressure measured by the first pressure sensing device 12a and the second pressure sensing device 12b will be. The controller 25 preferably determines the pressure drop across the filter F based on the data provided by the first pressure sensing device 12a and the second pressure sensing device 12b. When the pressure drop exceeds a predetermined threshold value, this is indicative of a clogged filter F and an alert may be issued by the controller 25 to a user, preferably via the transmitter/receiver 20. The user may receive the alert as an e-mail, text message, or even a phone call. If desired, the sensor 10 may include another output device such as a buzzer, alarm or light that is activated by the alert as well. The alert indicates that the filter F should be cleaned or replaced in order to maintain efficiency of the air conditioning system that it is in. If desired, the controller 25 may simply transmit all data via the transmitter/receiver 20 to a user, for example, a user's smart phone, tablet or computer where the data is compared to the threshold and the alert is issued, if necessary.

In an embodiment, the predetermined threshold for providing the alert may be determined based on a calibration measurement made when the filter F is newly installed. In this case, the first pressure sensing device 12a and the second pressure sensing device 12b measure air pressure shortly after the filter F has been installed when the filter is clean. The pressure drop during this initial measurement is preferably saved by the controller 25. The predetermined threshold may be determined based on a percentage of this calibration value. For example, the predetermined threshold may be set such that the alert is issued when the pressure drop is 30% larger than the calibration value. Alternatively, the predetermined threshold may be provided to the controller 25 via the transmitter/receiver 20, for example, from a user using a computer, smart phone, tablet or other similar device.

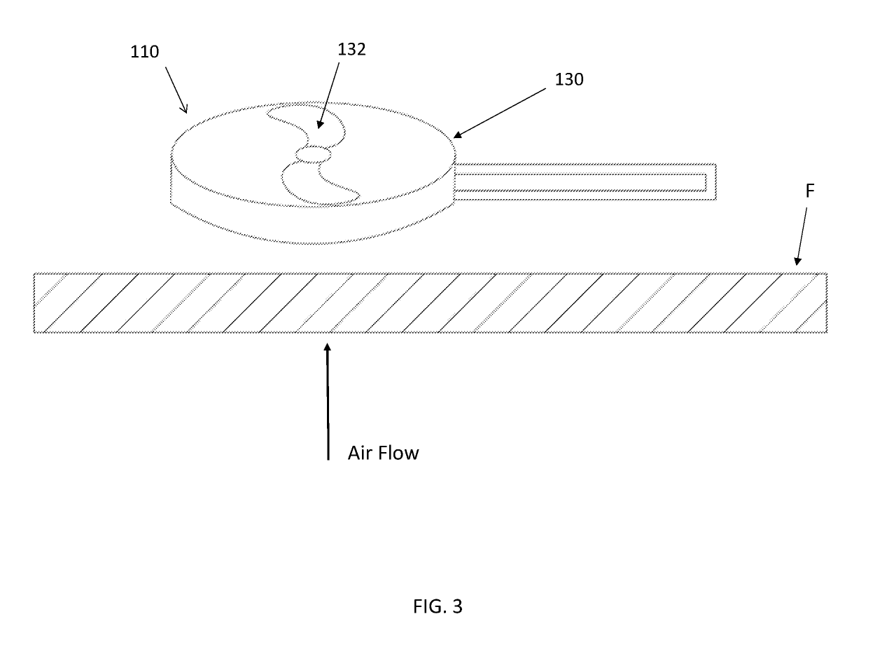

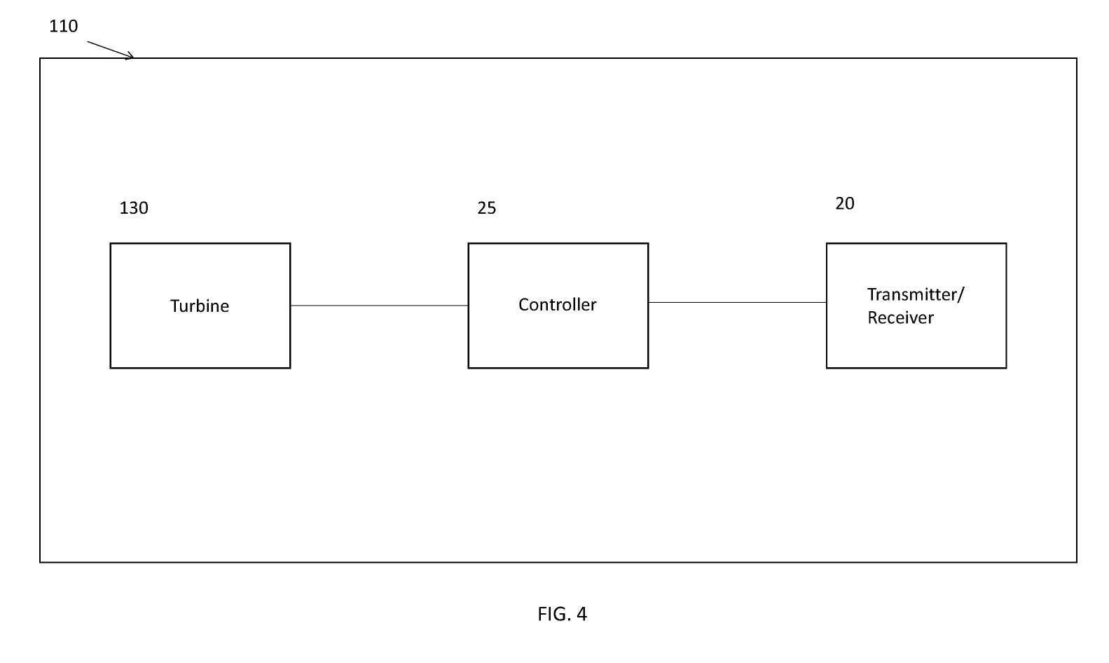

FIG. 3 illustrates another embodiment of an air filter sensor 110. In this embodiment, the sensor 110 is connected to the filter F on a side opposite that which the air flow approaches the filter. Any suitable fastener may be used to secure the sensor 110 to the filter, including the pin and recess discussed above, provided it does not substantially affect airflow. The sensor 110 preferably includes a small fan or turbine 130 that turns when air passes through its blades 132. The speed at which the turbine 130 turns is indicative of the airflow through the filter F. The sensor 110 preferably includes the controller 25 and transmitter/receiver 20 discussed above as can be seen in the exemplary block diagram of FIG. 4. In addition, a power supply may also be included in the sensor 110. Alternatively, the sensor 110 may be powered by the turbine 130, if desired. In this embodiment, a power storage device such as a battery or capacitor may be used to store power generated by the turbine 130, if desired.

The speed of the turbine 130 is indicative of the airflow through the filter F. As the filter F becomes clogged, the airflow on the downstream side thereof where the turbine 130 is positioned will drop. In a preferred embodiment, a calibration speed of the turbine is determined when the sensor 110 is installed on a clean filter F. The controller 25 is preferably connected to the turbine 130 such that data regarding the speed of the turbine is provided to the controller. This data may be in the form of a voltage generated by the turbine 130, for example. Alternatively, a speed sensor may be provided to simply indicate the speed of the blades 132.

In this embodiment, the controller 25 will preferably determine the speed of the turbine 130 periodically and will issue an alert if the speed drops below a predetermined speed threshold. As noted above, the controller 25 may simply transmit data to an external mobile device of a user where the comparison to the speed threshold is made. This predetermined speed threshold may be based on a percentage of the calibration speed, for example, the alert may issue if the current speed is more than 30% less than the calibration speed. The alert is preferably transmitted as discussed above with respect to the sensor 10.

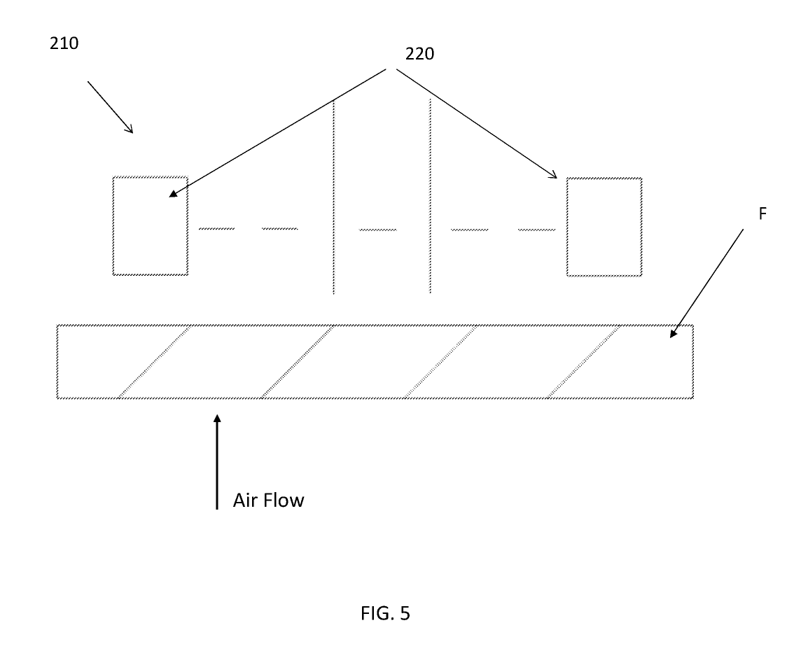

Another embodiment of an air filter sensor 210 is illustrated in FIG. 5. The air filter sensor 210 is preferably mounted on the filter F such that a laser speed sensor 220 is positioned on the side of the filter opposite that from which the air enters the filter during operation of the air conditioning system. The laser speed sensor 220 is used to determine a speed of the airflow on this side of the filter F and is secured to the filter F is any desired manner. The sensor 210 preferably determines a calibration speed when first installed or activated on a clean filter in a manner similar to that described above. The laser speed sensor 220 detects a speed of airflow using a laser. Such devices detect changes in airflow based on disruptions in a laser beam and are well known. The controller 25 will periodically check the speed of the airflow based on data provided from the laser speed sensor 220 and will issue an alert in the manner explained above if the air speed falls below the speed threshold explained above.

In a preferred embodiment, each of the sensors 10, 110, 210 are removably mounted on the filter F such that they can be installed onto virtually any air filter used in a wide variety of air conditioning systems. The transmitter/receiver 20 may be a Wi-Fi device, Bluetooth device or may include cellular connectivity such that the sensors 10, 110 and 210 can easily communicate with a user's smartphone, tablet or other mobile device or computer. In an embodiment, the controller 25 will transmit all of the data it receives to a user's smart phone, tablet or computer where it may be saved or displayed to the user either periodically or on a continuing basis so that the user can track the status of the filter F. This information may be presented to the user visually in the form of a graph, for example. This information will aid the user both in monitoring the real time status of the filter F as well as predicting when the filter should be replaced or cleaned.

The sensors 10, 110, 210 need not be active all of the time and measurements may be made only periodically since it takes a fair amount of time for a filter to get clogged. The controller may compare data to the threshold amounts on a daily basis, for example. Thus, the sensors utilize a relatively small amount of power. It is preferred that measurements are made while the air conditioning system in which the filter is mounted is in the same state. This may be accomplished by monitoring the state of the air conditioning system or receiving a command from a user based on the state of the air conditioning system.

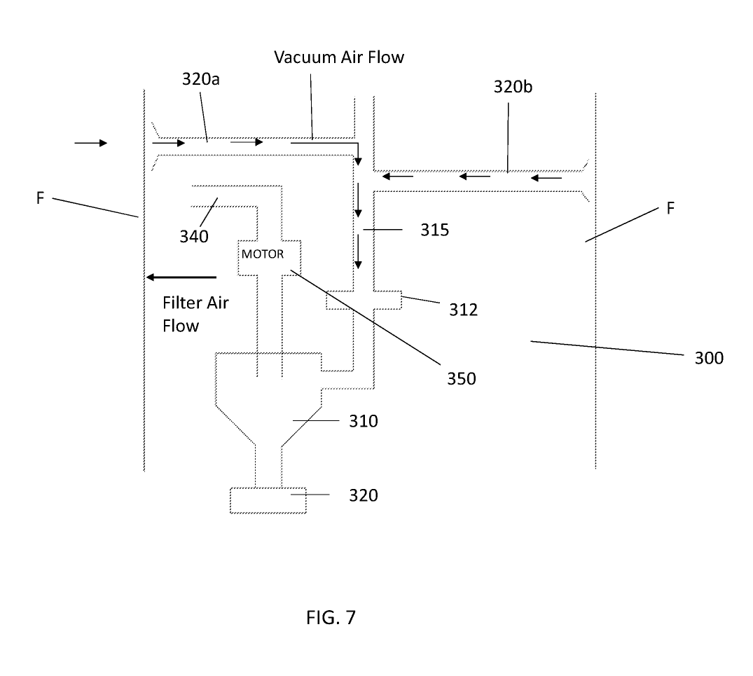

FIG. 7 illustrates a cleaning system 300 for use in cleaning a filter F. The filter F in FIG. 7 is a cylindrical type filter in which air enters through the open top end illustrated in FIG. 7 and through the filter F into the air conditioning system. If desired, the sensors 10, 110, 210 discussed above may be fastened to the filter F to monitor the status thereof.

In the event that the filter F becomes dirty, the system 300, may clean the filter F. As illustrated, the system 300 includes a motor 350 in fluid communication with a cyclonic separation chamber 310. A fan (not shown) of the motor 350 spins to draw air into the cyclonic separation chamber 310 where particles of dirt or debris are separated from the air and fall into the collection element 320. The clean air is discharged via the discharge element 340. The cyclonic separation chamber 310 is preferably in fluid communication with at least vacuum tubes 320a, 320b which extend radially outward from central tube 315 toward the inner surface of the filter F such that the free ends of the tubes 320a, 320b are positioned adjacent to the filter. In a preferred embodiment, a rotating joint 312 is provided between the cyclonic separation chamber 310 and the central tube 315 to allow the central tube and the vacuum tubes 320a, 320b to rotate within the cylindrical filter to clean the filter. While multiple vacuum tubes 320a, 320b are illustrated, a single vacuum tube may be used if desired.

In operation, when cleaning is necessary or desired, the vacuum motor 350 is activated such that air and debris are sucked from the surface of the filter F through the central tube 315 and chamber 30 to separate debris into the collection element 320. As noted above, the vacuum tubes 320a, 320b preferably rotate with the central tube 315 via the rotating joint 312 such that the entire cylindrical surface of the filter F is cleaned. If desired, the vacuum tubes 320a, 320b may be mounted on the central tube 315 such that they rotate while the tube does not. In addition, the vacuum tubes 320a, 320 are preferably movable up and down such that substantially the entire surface of the filter F is cleaned over its entire length. This up and down movement may be accomplished via a telescoping connection between the centrifugal separation chamber 312 and the central tube 315 or in any other desired manner. In an embodiment, the free end of the vacuum tuber 20a may be extended such that it spans substantially the surface of the filter such that up and down motion thereof is not required. The rotation of the central tube 315 and the tubes 320a, 320b may be accomplished using a rotation gear, that may be driven by the motor 350, for example, or any other suitable mechanism, including but not limited to a belt or strap connected between the motor and the central tube 315.

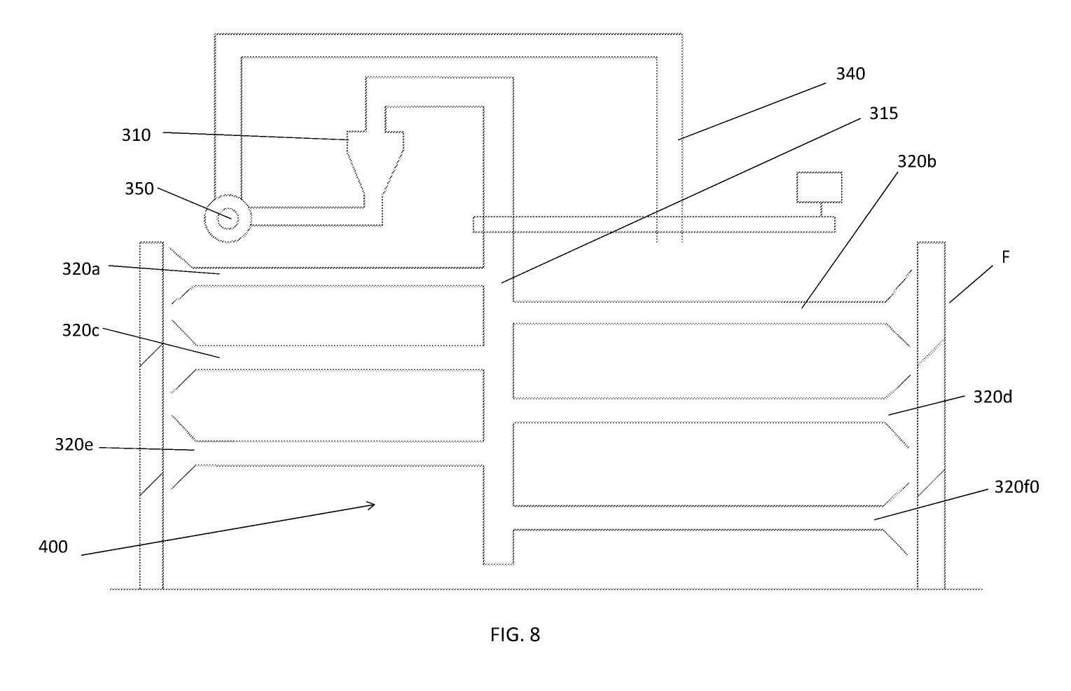

FIG. 8 illustrates an alternative embodiment of an air filter cleaning system 400. The system 400 preferably includes a motor 350, centrifugal separation chamber 310 and discharge element 340. These elements, however, are mounted outside of the cylindrical filter F, in a ceiling for example. In this embodiment the central tube 315 extends into the cylindrical filter area and includes vacuum tubes 320a, 320b, 320c, 320d, 320e, 320f which extend radially therefrom with the free ends thereof adjacent to the surface of the filter F. The vacuum tubes 320a-320f are staggered vertically along the length of the filter F. The central tube 315 rotates with the tubes 320a-320f, however, need not necessarily do so. Since the tubes 320a-320f are staggered, vertical movement of these vacuum tubes is unnecessary to clean the entire length of the filter F. Alternatively, as noted above, a single vacuum tube may be provided with a widened free end that spans substantially the surface of the filter F. Rotation of the tube(s) may be provided by a rotation gear similar to that described above or any other suitable arrangement.

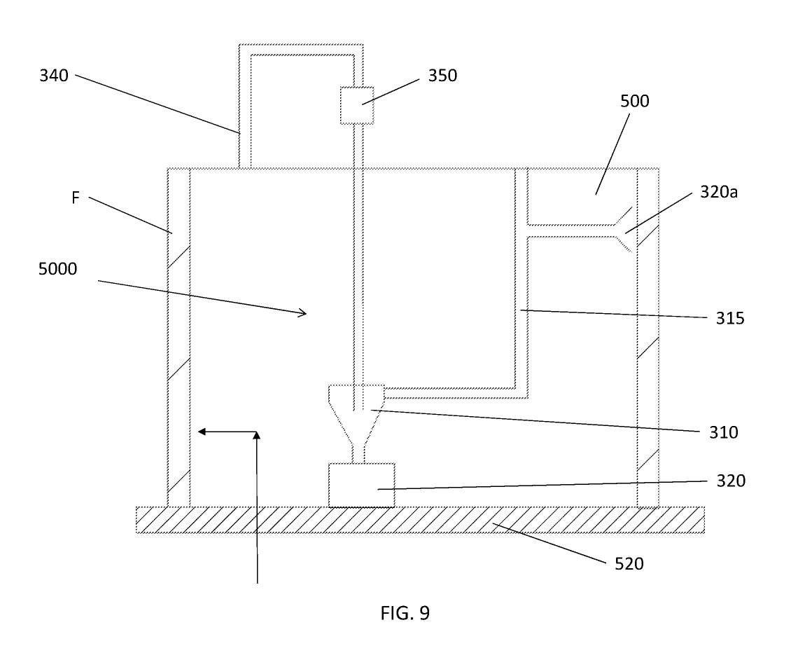

FIG. 9 illustrates an alternative embodiment of a system 500 for cleaning an air filter F in which the filter is mounted in a ceiling vent. In this case, the motor 350 is preferably provided above the filter F with the cyclonic separation chamber 310 and collection element 320 are provided toward a bottom end of the filter. A connecting tube 510 connects the motor 350 and the cyclonic separation chamber 310. In this embodiment, the central tube 315 extends from a top and side portion of the cyclonic separation chamber 310 and is connected to a vacuum tube 320a. While a single vacuum tube 320a is illustrated, additional radially extending vacuum tubes, such as the tubes 320b-320f discussed above may also be included. In this embodiment, it is preferred that the separation chamber 310 and collection element 320 rotate with the central tube 315 and the cyclonic separation chamber. In this embodiment, the air flow is upward through the ceiling vent 520 and into the open bottom end of the filter F.

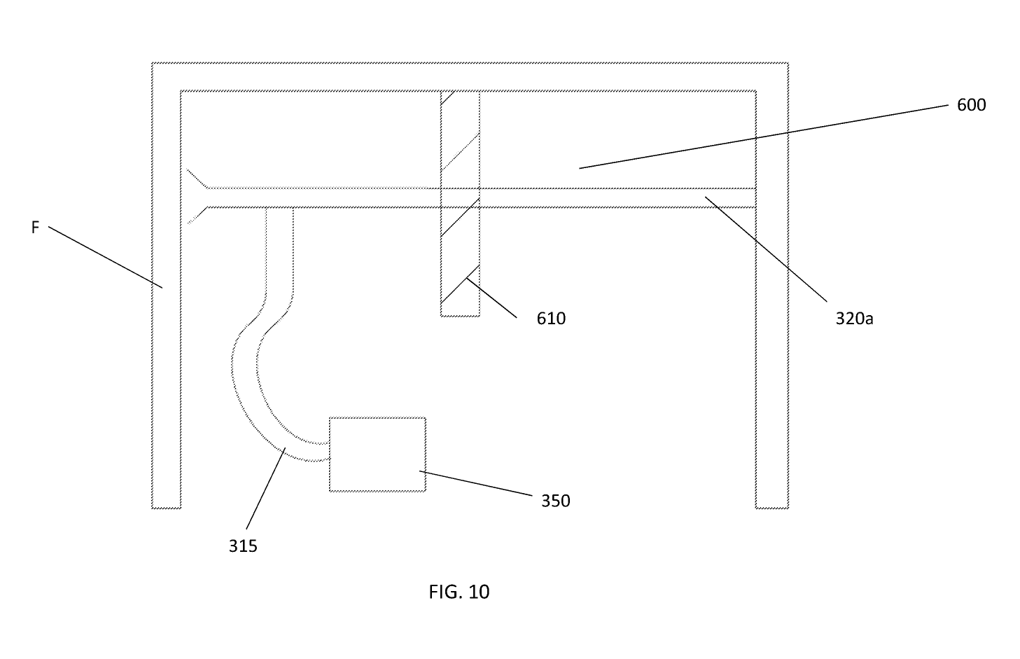

FIG. 10 illustrates another embodiment of a system for cleaning an air filter 600. In this embodiment, the central tube 315 is flexible and is connected to radially extending vacuum tube 320a offset from the center thereof. The vacuum tube 320a is mounted on a vertical shaft 610 that extends vertically downward into the center of the filter F. The shaft 610 may include an outer thread or spiral about which the vacuum tube 320a rotates during operation.

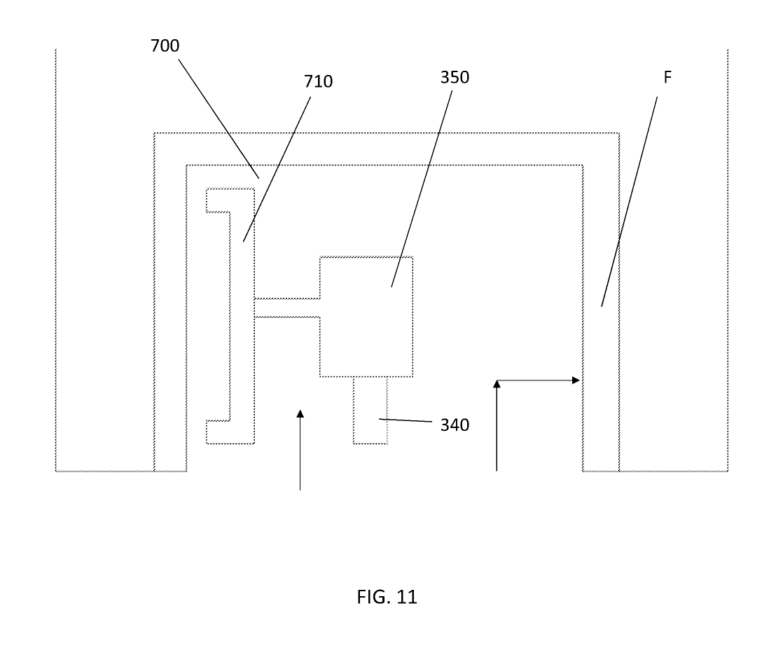

In FIG. 11, a cleaning system 700 in accordance with another embodiment of the present invention is illustrated. In this embodiment, the radially extending vacuum tube 320a is replaced by a vertically extending nozzle assembly 710 in fluid communication with the fan of the motor 350 to provide suction. A centrifugal separation chamber may also be provided. The motor 350 and the discharge 340 are provided at the bottom end of the filter F. The motor 350 and the nozzle assembly 710 rotate such that the inner cylindrical surface of the filter F is cleaned by the nozzle assembly.

All of the cleaning systems 300, 400, 500, 600 and 700 may be used in conjunction with the sensors 10, 110 and 210 discussed above. The systems may be activated based on the alert signal provided by the sensors to provide for automatic filter cleaning when needed. For this purpose, the systems may include a wireless or wired transmitter/receiver (not shown) to receive control signals, if desired. Alternatively, the cleaning systems 300, 400, 500, 600 and 700 may be activated by a user via a smart phone, tablet, computer or cellular device. Further, if desired, the cleaning systems 300, 400, 500, 600 and 700 preferably include a manual activation switch to allow them to be turned on. In another embodiment, the cleaning systems 300, 400, 500, 600 and 700 will automatically be activated periodically. The time between activations may be set by a user remotely or via an input device provided in the systems.

In addition, in a preferred embodiment, a monitoring device or sensor is provided to monitor the refrigerant level in the air conditioning system. Refrigerant materials include Freon and others. The sensor may use any desired sensing technology and preferably includes a controller similar to controller 25 noted above that receives information regarding the refrigerant level and sends an alert signal, preferably to a smartphone or smart device when the refrigerant level reaches a predetermined pressure threshold that would reduce operating efficiency lower than an acceptable level. The alert may be an audible signal, but is preferably a wireless signal transmitted wirelessly, for example, via the wireless transmitter/receiver 20 discussed above. Alternatively, the data regarding refrigerant level may be transmitted to an external device, such as a smart phone or computer where the data is analyzed and the alert signal initiated.

Although the present invention has been described in relation to particular embodiments thereof, many other variations and modifications and other uses will become apparent to those skilled in the art.

What is claimed is:

1. An air filter sensor comprising;
a first component positioned on a downstream side of the air filter and configured to provide an indication of airflow on the downstream side of the air filter.

2. The air filter sensor of claim 1 further comprising
a controller, connected to the first component and configured to determine whether airflow on the downstream side of the air filter is less than a predetermined threshold based on the indication of airflow; and to issue an alert when the airflow on the downstream side of the air filter is less than the predetermined threshold.

3. The air filter sensor of claim 2, further comprising a second component positioned on an upstream side of the air filter and configured to provide an indication of airflow on the upstream side of the air filter, where the second component is connect to the controller and the predetermine threshold is a maximum permissible difference between airflow on the upstream side of the air filter and air flow on the downstream side of the air filter.

4. The air filter sensor of claim 2, wherein the first component is a fan that turns with airflow such that a speed of the fan indicates airflow on the downstream side of the filter.

5. The air filter sensor of claim 2, further comprising a transceiver connected to the controller and wherein the alert is transmitted using the transceiver.

6. The air filter sensor of claim 5, wherein the transceiver transmits and receives information in a wireless communications network.

7. The air filter sensor of claim 2 further comprising a power source configure to provide power to at least the controller and the first component.

8. The air filter sensor further comprising a memory element connected to the controller and configured to store data.

9. The air filter sensor of claim 8, wherein the data stored in the memory element includes the predetermined threshold.

10. The air filter of claim 8, wherein the data stored in the memory element included instructions executed by the controller to determine the predetermined threshold.

11. An air filter cleaning system for cleaning an air filter comprises:
a fan:
a separation chamber in fluid communication with the fan and configured to separate particles from air provided to the separation chamber by the fan;
a suction head, in fluid communication with the separation chamber and positioned such that an inlet thereof is positioned adjacent to an upstream side of the air filter such that the suction head removes particles from the upstream side of the air filter.

12. The air filter cleaning system of claim 11 further comprising a motor connected to the fan to drive the fan.

13. The air filter cleaning system of claim 11, wherein the fan is positioned downstream of the separation chamber and discharges air that is substantially particle free.

14. The air filer cleaning system of claim 11 wherein the suction head is movable over substantially all of the upstream side of the air filter.

15. The air cleaning system of claim 11, further comprising a main suction tube extending from the separation chamber, wherein the suction head extends radially from the main suction tube.

16. The air cleaning system of claim 15, wherein the suction head is rotatable relative to the main suction head.

17. The air cleaning system of claim 15, further comprising at least a second suction head extending from the main suction tube with an inlet thereof positioned adjacent to the upstream side of the air filter.

18. The air cleaning system of claim 17, wherein said second suction head extends from an opposite side of the main suction tube than the suction head.

19. The air cleaning system of claim 17, wherein said second suction head extends from the main suction tube at a position below the suction head.

20. The air filter cleaning system of claim further comprising an air filter sensor positioned on a downstream side of the air filter and configured to provide an indication of airflow on the downstream side of the filter, wherein the air filter sensor issues an alert when airflow on the downstream side of the filter is less than a predetermined threshold and the alter signal is used to activate the fan.
